(19) United States
(12) Patent Application Publication
(10) Pub. No.: US 2013/0163623 A1
(43) Pub. Date: Jun. 27, 2013

(54) High Spectral Brightness Laser Generating Device and Method Thereof

(71) Applicant: Chen-Bin Huang, Hsinchu City (TW)

(72) Inventor: Chen-Bin Huang, Hsinchu City (TW)

(73) Assignee: NATIONAL TSING HUA UNIVERSITY, Hsinchu (TW)

(21) Appl. No.: 13/427,152

(22) Filed: Mar. 22, 2012

(30) Foreign Application Priority Data
Dec. 27, 2011 (TW) 100149036

(51) Int. Cl. H01S 3/10

(52) U.S. Cl. 372/25

(57) ABSTRACT

This invention discloses a high spectral brightness laser generating device and a method thereof, which comprises a laser generator, a dispersion-increasing fiber. The laser generator generates a first laser pulse. The dispersion-increasing fiber is coupled to the laser generator. The first laser pulse becomes a second laser pulse by passing through the dispersion-increasing fiber. The bandwidth of the second laser pulse is narrower than that of the first laser pulse. The unit brightness of the second laser pulse is higher than that of the first laser pulse.

### CROSS-REFERENCE TO RELATED APPLICATION

This application claims the benefit under 35 U.S.C. §119 of Taiwan Patent Application No. 100149036, filed Dec. 27, 2011, which is hereby incorporated by reference in its entirety.

### BACKGROUND

1. Field of the Invention

The present invention relates to a high spectral brightness laser generating device and a method thereof, and more particularly to the high spectral brightness laser generating device and method that use a dispersion-increasing fiber to narrow the bandwidth of a laser pulse.

2. Description of Related Art

At present, laser has been used extensively in many different areas including the general electric appliance, high-tech and communication industries and particularly plays an essential role in atomic or molecular spectroscopy such as the nonlinear microscope and optical coherence tomography. In applications, the energy of a wideband light source is usually reallocated to a narrow spectral range to improve the unit brightness of the laser beams, or a bandwidth compression technology is adopted to improve the unit brightness. The bandwidth of laser beams can be compressed by passing the laser beams through a photonic crystal fiber or a dispersion-increasing fiber. However, if the bandwidth is compressed by present existing technology, the effect of modulating the frequency of the wavelength cannot be concurrently achieved.

In view of the aforementioned problem, manufacturers and designers of the related industry attempt to improve the unit brightness of the laser beams after the bandwidth is compressed in order to achieve the effect of modulating the frequency of the wavelength at the same time in the bandwidth compression process. Therefore, the inventor of the present invention conducted extensive researches and experiments, and finally developed a high spectral brightness laser device and a method thereof to overcome the problems of the prior art.

### BRIEF SUMMARY

In view of the aforementioned problems of the prior art, it is a primary objective of the invention to provide a high spectral brightness laser generating device and a method thereof to overcome the problem of unable to improve the unit brightness after the bandwidth of the laser pulse is expanded. Such desired process is ideally lossless.

To achieve the foregoing objective, the present invention provides a high spectral laser device comprising: a laser generator and a dispersion-increasing fiber (DIF). The laser generator generates a first laser pulse. The dispersion-increasing fiber is coupled to the laser generator. The first laser pulse is passed through the dispersion-increasing fiber to become a second laser pulse. The second laser pulse has a bandwidth narrower than that of the first laser pulse and a unit brightness higher than that of the first laser pulse.

Wherein, the dispersion-increasing fiber has a chromatic dispersion value which increases with the length of the dispersion-increasing fiber.

Wherein, the pulse energy outputted from the laser generator increases with the wavelength of the second laser pulse.

Wherein, the pulse energy outputted from the laser generator is increased to shift a central spectrum position of the second laser pulse.

Wherein, the bandwidth of the second laser pulse decreases as the pulse amplitude outputted from the laser generator increases.

To achieve the foregoing objective, the present invention further provides a high spectral brightness laser generating method comprising the steps of: coupling a dispersion-increasing fiber to a laser generator; generating a first laser pulse by the laser generator; and passing the first laser pulse through the dispersion-increasing fiber to become a second laser pulse; wherein, the second laser pulse has a bandwidth narrower that that of the first laser pulse and a unit brightness higher than that of the first laser pulse.

Wherein, the dispersion-increasing fiber has a chromatic dispersion value which increases with the length of the dispersion-increasing fiber.

Wherein, the pulse energy outputted from the laser generator increases with the wavelength of the second laser pulse.

Wherein, the pulse energy outputted from the laser generator is increased to shift a central spectrum position of the second laser pulse.

Wherein, the method further comprises the step of increasing the pulse amplitude outputted from the laser generator to decrease the bandwidth of the second laser pulse.

In summation, the high spectral brightness laser generating device and method of the present invention have one or more of the following advantages:

(1) In the high spectral brightness laser generating device and method, a laser pulse is passed through a dispersion-increasing fiber whose chromatic dispersion value increases with distance, so as to obtain a laser pulse of a narrower bandwidth while enhancing the unit brightness of the laser pulse.

(2) In the high spectral brightness laser generating device and method, a laser pulse is passed through a dispersion-increasing fiber whose chromatic dispersion value increases with distance, and the pulse energy of the laser pulse outputted from the laser generator is adjusted to obtain laser pulses with different wavelengths to improve the practical application of the laser pulse.

### BRIEF DESCRIPTION OF THE DRAWINGS

FIG. 1 is a first schematic view of a high spectral brightness laser generating device of the present invention;

FIG. 2 is a second schematic view of a high spectral brightness laser generating device of the present invention;

FIG. 3 is a third schematic view of a high spectral brightness laser generating device of the present invention;

FIG. 4 is a first schematic view of a high spectral brightness laser generating device in accordance with a first preferred embodiment of the present invention;

FIG. 5 is a second schematic view of a high spectral brightness laser generating device in accordance with the first preferred embodiment of the present invention;

FIG. 6 is a third schematic view of a high spectral brightness laser generating device in accordance with the first preferred embodiment of the present invention;

FIG. 7 is a schematic view of a high spectral brightness laser generating device in accordance with a second preferred embodiment of the present invention; and

FIG. 8 is a flow chart of a high spectral brightness laser generating method of the present invention.

### DETAILED DESCRIPTION OF THE EMBODIMENTS

The technical characteristics, contents, advantages, and effects of the present invention will become apparent with the detailed description of preferred embodiments accompanied with related drawings as follows, and the drawings are not necessarily drawn according to the actual proportion and precision, and they are provided for the purpose of illustrating the present invention only, but not intended for limiting the scope of the invention.

The high spectral brightness laser generating device of the present invention can use a dispersion-increasing fiber to obtain a laser pulse with a narrower bandwidth which is applicable for spectral analyzing devices including but not limiting to optical coherence tomography and nonlinear microscopy.

The high spectral brightness laser generating device and method in accordance with the present invention are described by the following preferred embodiments and related drawings. It is noteworthy to point out same numerals are used to represent same respective elements respectively.

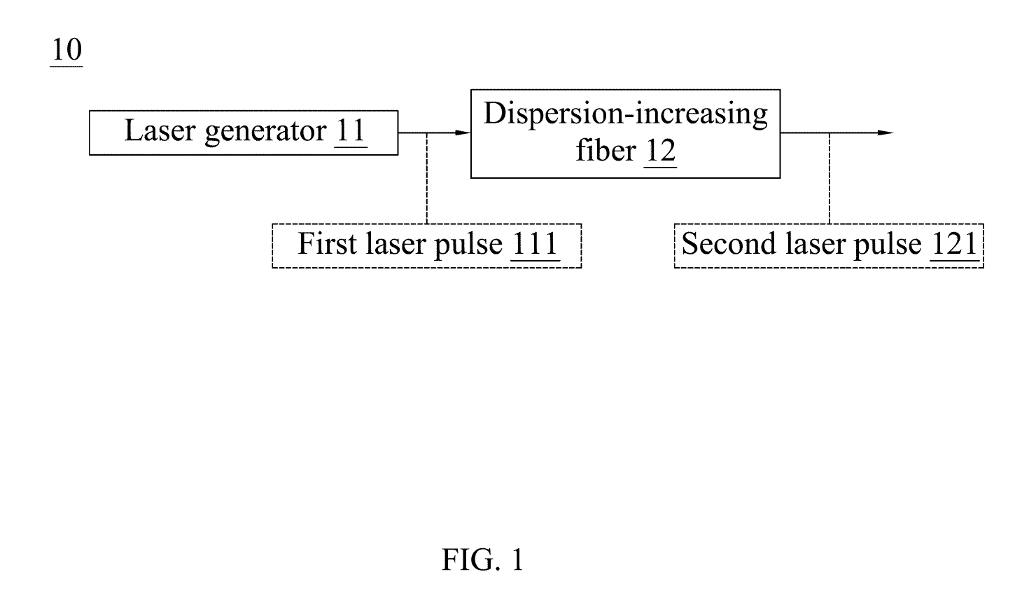

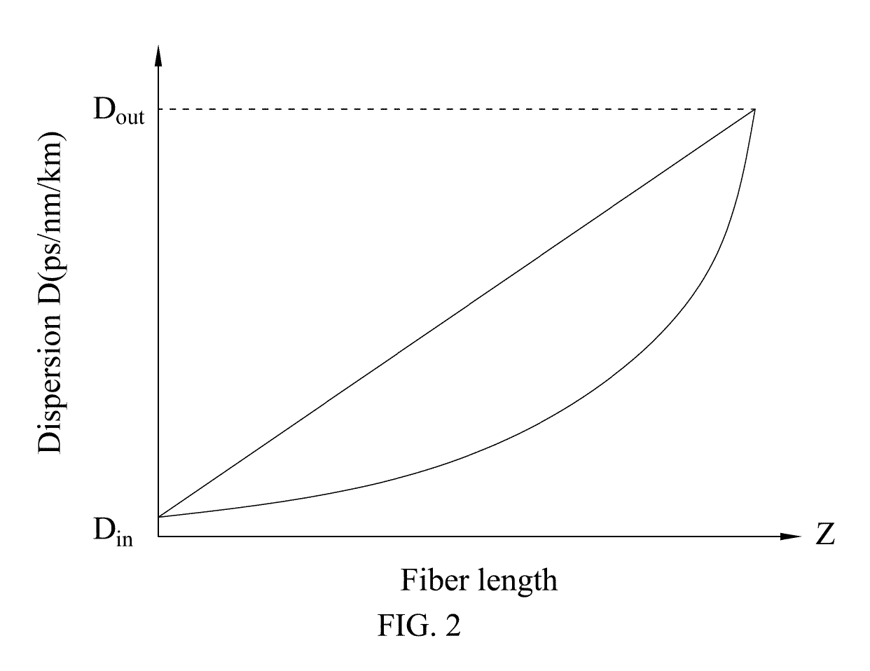

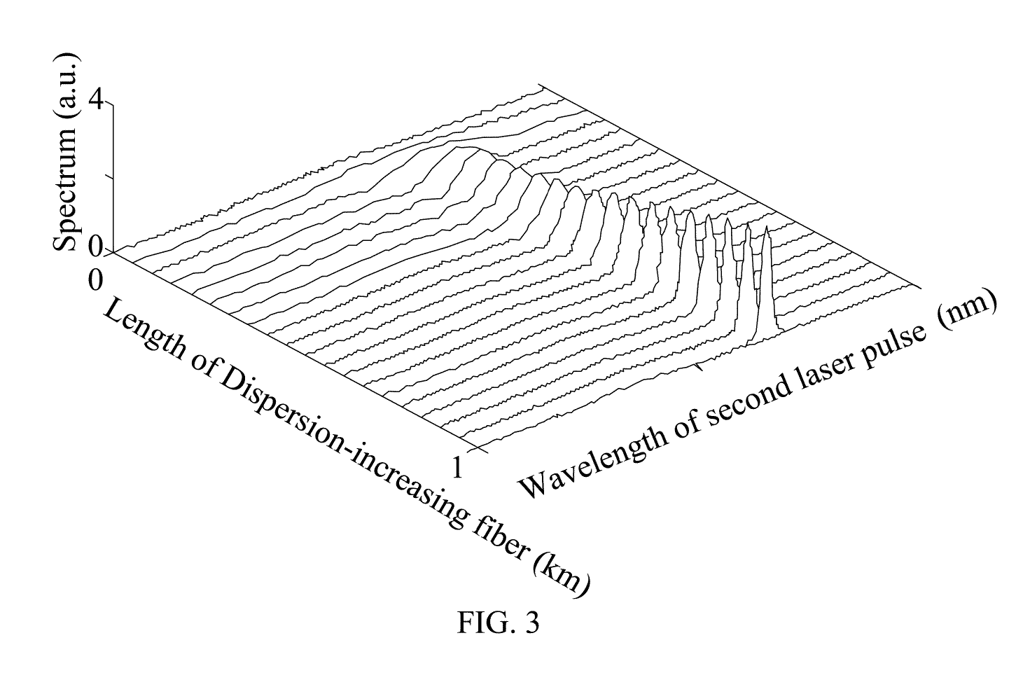

With reference to FIGS. 1 to 3 for the first, second and third schematic views of a high spectral brightness laser generating device of the present invention respectively, a laser device 10 comprises: a laser generator 11 and a dispersion-increasing fiber 12 (DIF). The laser generator 11 is coupled to the dispersion-increasing fiber 12. The laser generator 11 is provided for generating a first laser pulse 111 which can pass through the dispersion-increasing fiber 12 to become a second laser pulse 121. In FIG. 2, the dispersion-increasing fiber 12 has a chromatic dispersion value which increases with the length of the dispersion-increasing fiber 12. However, this is one of the examples of the dispersion-increasing fiber 12 only, but practical applications are not limited to this example. The second laser pulse 121 has a bandwidth narrower than that of the first laser pulse 111, so that the second laser pulse 121 has a higher unit brightness. Wherein, the greater the distance of the first laser pulse ill passing through the dispersion-increasing fiber 12, the greater is the compression percentage of the second laser pulse 121. In FIG. 2, the longer the dispersion-increasing fiber 12, the narrower is the bandwidth of the second laser pulse 121. The longer the dispersion-increasing fiber 12, the greater is the central wavelength of the second laser pulse 121. In other words, the greater the distance of the first laser pulse 111 passing through the dispersion-increasing fiber 12, the narrower is the bandwidth of the second laser pulse 121 generated by the dispersion-increasing fiber 12, and the longer is the central wavelength.

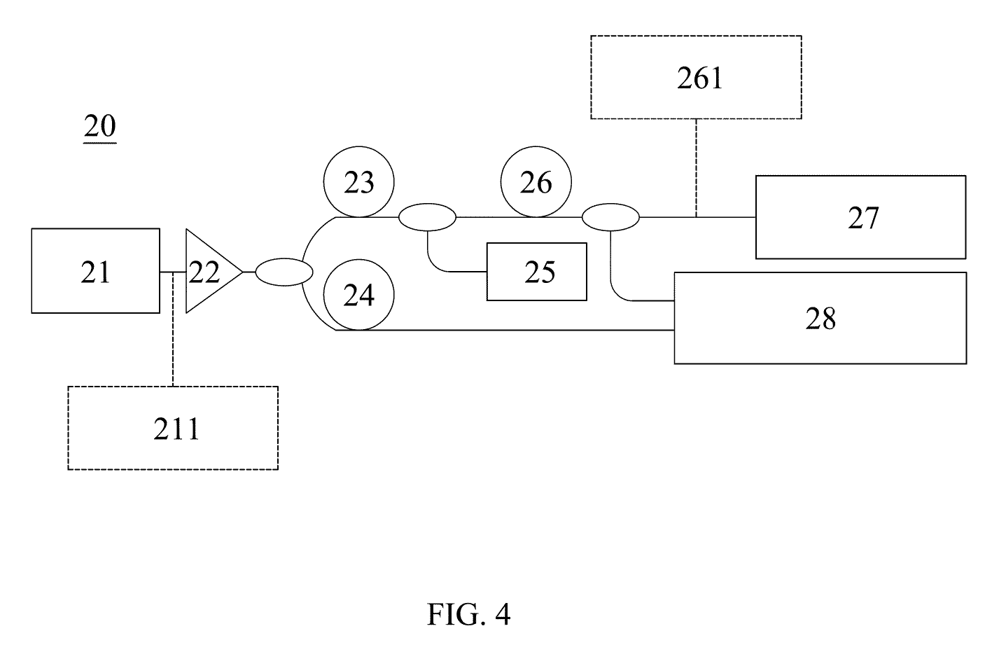

With reference to FIG. 4 for a first schematic view of a high spectral brightness laser generating device in accordance with the first preferred embodiment of the present invention, the high spectral brightness laser generating device is applied to a spectrometer 20 and comprises: a laser generator 21, an Erbium-doped fiber amplifier (EDFA) 22, a first dispersion-compensating fiber (DCF) 23, a second dispersion-compensating fiber (DCF) 24, a power meter (PM) 25, a dispersion-increasing fiber (DIF) 26, an optical spectrum analyzer (OSA) 27 and an intensity cross-correlator 28. Wherein, the laser generator 21 of this preferred embodiment generates an Er-doped mode-locked fiber laser (MLFL), but the practical application is not limited to the MLFL only. The laser generator 21 is coupled to the Erbium-doped fiber amplifier 22. The Erbium-doped fiber amplifier 22 is coupled to the first dispersion-compensating fiber 23 and the second dispersion-compensating fiber 24. The first dispersion-compensating fiber 23 is coupled to the power meter 25 and the dispersion-increasing fiber 26. The dispersion-increasing fiber 26 is coupled to the optical spectrum analyzer 27 and the intensity cross-correlator 28. The laser generator 21 generates a first laser pulse 211 and passes through an Erbium-doped fiber amplifier 22 before entering into a first dispersion-compensating fiber 23 and a second dispersion-compensating fiber 24. Wherein, the Erbium-doped fiber amplifier 22 can be coupled to a fiber optical coupler to allocate the first laser pulse 211 to the first dispersion-compensating fiber 23 and the second dispersion-compensating fiber 24. Wherein, the first laser pulse 211 and the second laser pulse 261 are preferably solitons. The first laser pulse 211 passes through the first dispersion-compensating fiber 23 and then passes through the dispersion-increasing fiber 26 to become a second laser pulse 261, and enters into the optical spectrum analyzer 27. Some of the second laser pulse 261 enters into the intensity cross-correlator and the first laser pulse 211 passes through the second dispersion-compensating fiber 24, and then enters into the intensity cross-correlator 28. The first laser pulse passes through the dispersion-increasing fiber 26 to become a second laser pulse 261. During the process of passing the first laser pulse 211 through the first dispersion-compensating fiber 23, a portion of the first laser pulse 211 enters into the power meter 26. The power meter 26 is provided for monitoring the power intensity of the first laser pulse 211 entering into the dispersion-increasing fiber 26.

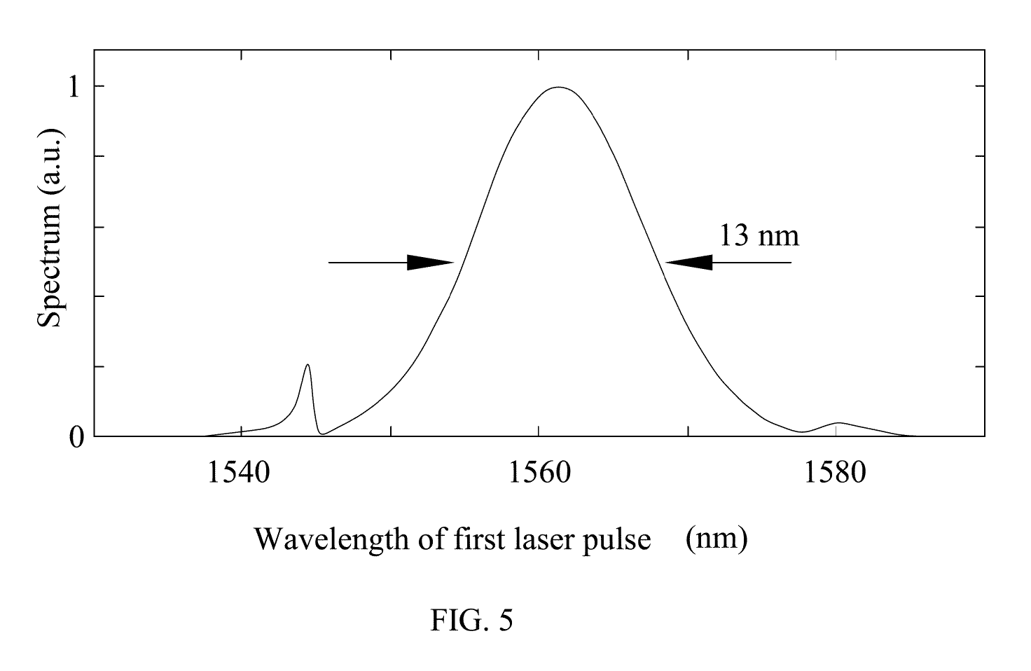

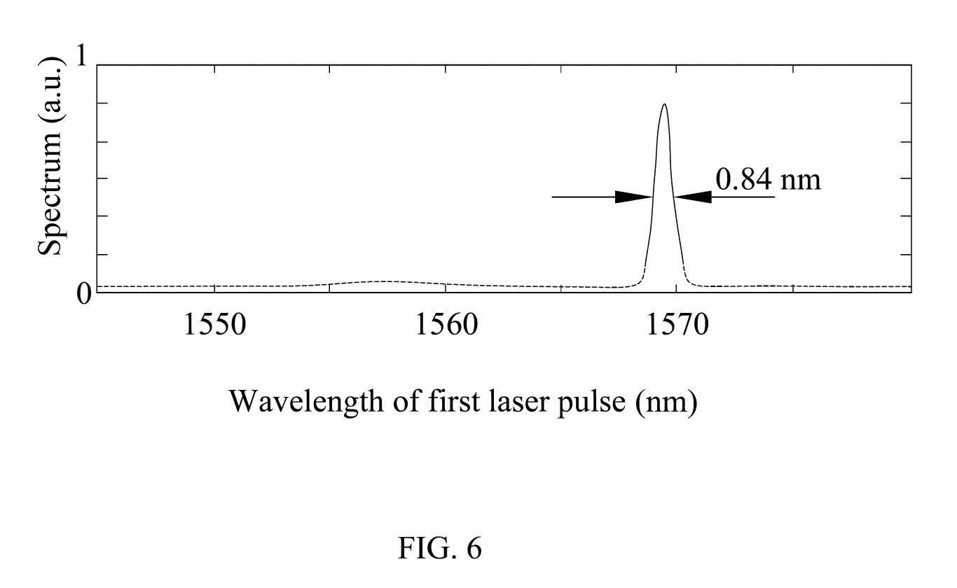

With reference to FIGS. 5 and 6 for the second and third schematic views of a high spectral brightness laser generating device in accordance with the first preferred embodiment of the present invention respectively, related configurations of the spectrometer 20 are similar to those described above, and thus will not be repeated. However, it is noteworthy to point out that the laser generator 21 of this preferred embodiment generates Er-doped mode-locked fiber laser (MLFL), and the following numeric values are provided for describing the change of related parameters in this preferred embodiment. The laser generator 21 has a pulse repetition frequency of 50 MHz, an average output power of 0.67 mW; and the dispersion-increasing fiber 26 has a linear color dispersion rate of 0.6 to 13.5 ps/nm/km. In FIG. 4, the laser generator 21 generates a first laser pulse 211 whose full width at half maximum (FWHM) bandwidth equals to 13 nm and the center wavelength equals to 1560 nm. After the first laser pulse 211 passes through the Erbium-doped fiber amplifier (EDFA) 22, a fiber optical coupler (3 dB Coupler) will uniformly allocate the first laser pulse 211 to the first dispersion-compensating fiber (DCF) 23 and the second dispersion-compensating fiber (DCF) 24. There are 95% of the first laser pulse 211 passing through the first dispersion-compensating fiber 23 will pass through the dispersion-increasing fiber (DIF) 26 to become a second laser pulse 261, and the other 5% of the first laser pulse 211 will enter into the power meter (PM) 25. The power meter 25 bases on the 5% of the first laser pulse 211 to monitor the power of the first laser pulse 211 entering into the dispersion-increasing fiber 26. Wherein, there are 90% of the second laser pulse 261 entering into optical spectrum analyzer (OSA) 27, and 10% of the second laser pulse 261 entering into the intensity cross-correlator 28. In FIG. 6, the first laser pulse 211 passes through the dispersion-increasing fiber 26 to become a second laser pulse 261 whose full width at half maximum (FWHM) bandwidth equals to 0.84 nm and whose center wavelength equals to 1569.5 nm.

From the description above, after the first laser pulse 211 passes through the dispersion-increasing fiber 26, the full width at half maximum (FWHM) bandwidth drops from 13 nm to 0.84 nm and the center wavelength rises from 1560 nm to 1569.5 nm. Wherein, the increase of center wavelength of the first laser pulse 211 shows a red-shift of the center spectral position of the first laser pulse 211. In other words, the dispersion-increasing fiber 26 can change the FWHM bandwidth of the first laser pulse 211 to a narrower bandwidth, and increase the center wavelength. Wherein, the second laser pulse 261 has a FWHM bandwidth narrower than that of the first laser pulse 211 and a unit brightness higher than that of the first laser pulse 211.

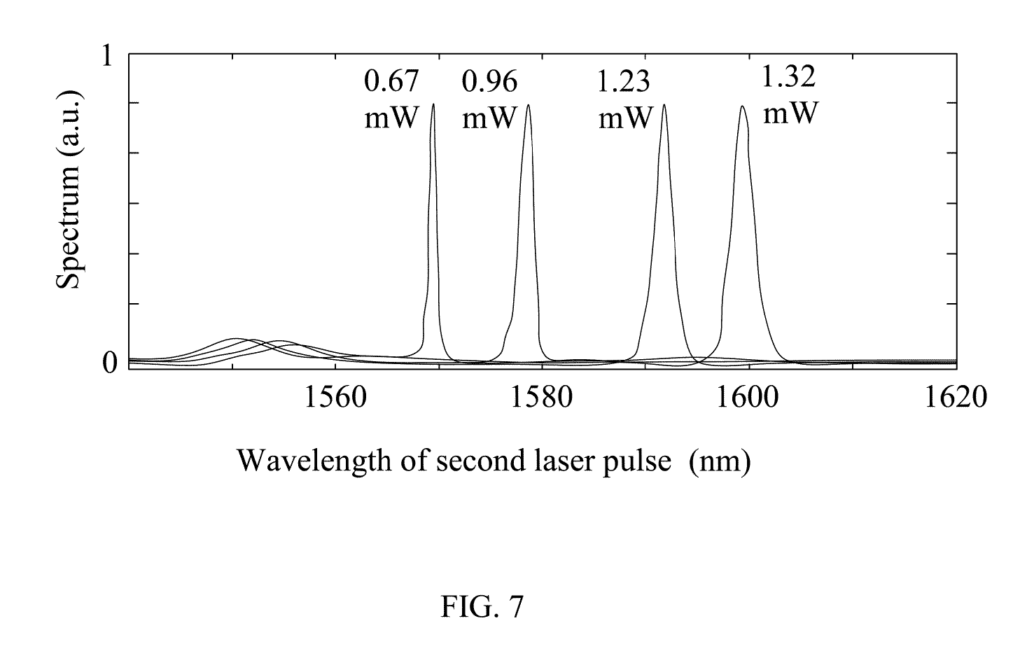

With reference to FIG. 7 for a schematic view of a high spectral brightness laser generating device in accordance with a second preferred embodiment of the present invention, the high spectral brightness laser generating device can be applied to a spectrometer (not shown in the figure), and related configurations of the spectrometer are similar to those of the foregoing preferred embodiment, and thus will not be repeated. However, it is noteworthy to point out that the aforementioned first preferred embodiment is demonstrated by the following numeric values, and same numerals are used to represent the same respective elements below. The laser generator 21 has a pulse repetition frequency of 50 MHz and an average output power of 0.67 mW. The first laser pulse 211 has a center wavelength of 1560 nm and passes through the dispersion-increasing fiber 26 to become a second laser pulse 261, and the second laser pulse 261 has a wavelength of 1569.5 nm. In FIG. 7, the laser generator 21 has an average output power of 0.67 mW, and the corresponding second laser pulse 261 has a center wavelength of 1569.5 nm. If the average output power of the laser generator 21 is increased to 0.96 mW, the center wavelength of the corresponding second laser pulse 261 will be equal to 1578.7 nm. If the average output power of the laser generator 21 is added with 1.23 mW and 1.32 mW, the corresponding second laser pulse 261 will have center wavelengths of 1591.7 nm and 1599.3 nm respectively. Obviously, the larger the average output power of the laser generator 21, the larger is the center wavelength of the second laser pulse 261. In other words, the average output power of the laser generator 21 can be increased to produce a red-shift of the center spectral position of the second laser pulse 261.

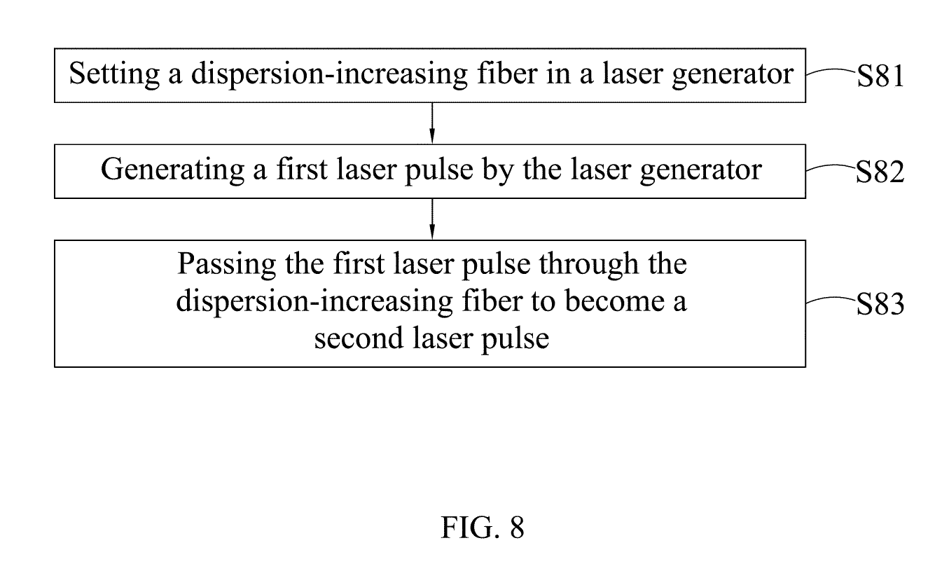

With reference to FIG. 8 for a flow chart of a high spectral brightness laser generating method of the present invention, the method comprises the following steps.

S81: a dispersion-increasing fiber is set in a laser generator.

S82: a first laser pulse is generated by the laser generator.

S83: the first laser pulse passes through the dispersion-increasing fiber to become a second laser pulse.

Wherein, the second laser pulse has a bandwidth narrower than that of the first laser pulse and a unit brightness higher than that of the first laser pulse.

The details and implementations of the high spectral brightness laser generating method of the present invention have been described in the section of the high spectral brightness laser generating device above, and thus will not be repeated.

In summation of the description above, the high spectral brightness laser generating device and method in accordance with the present invention passes a laser pulse through a dispersion-increasing fiber whose chromatic dispersion value increases with distance to obtain a laser pulse with a narrower bandwidth, while enhancing the unit brightness of the laser pulse, and adjusts the amplitude of the laser pulse outputted from the laser generator to obtain laser pulses of different wavelengths. Obviously, the invention improves the practical application of the laser pulse.

1. A high spectral brightness laser generating device, comprising:
a laser generator, for generating a first laser pulse;
a mode-locked fiber amplifier, coupled to the laser generator and mode-locking the first laser pulse as a mode-locked fiber laser pulse; and
a dispersion-increasing fiber (DIF), coupled to the mode-locked fiber amplifier;
wherein, when the first laser pulse passes through the dispersion-increasing fiber, the first laser pulse becomes a second laser pulse, and the second laser pulse has a bandwidth narrower than that of the first laser pulse and a unit brightness higher than that of the first laser pulse.

2. The high spectral brightness laser generating device of claim 1, wherein the dispersion-increasing fiber has a chromatic dispersion value, and the chromatic dispersion value increases with the length of the dispersion-increasing fiber.

3. The high spectral brightness laser generating device of claim 1, wherein a wavelength of the second laser pulse increases as a pulse energy of the first laser pulse increases.

4. The high spectral brightness laser generating device of claim 1, wherein the second laser pulse has a central spectral position, which is shifted as a pulse energy of the first laser pulse increases.

5. The high spectral brightness laser generating device of claim 1, Wherein the bandwidth of the second laser pulse decreases as a pulse amplitude of the first laser pulse increases.

6. A high spectral brightness laser generating method, comprising the steps of:
coupling a dispersion-increasing fiber to a mode-locked fiber amplifier and coupling the mode-locked fiber amplifier to a laser generator;
generating a first laser pulse by the laser generator; and
passing the first laser pulse through the mode-locked fiber amplifier to mode-lock the first laser pulse as a mode-locked fiber laser pulse;
passing the first laser pulse through the dispersion-increasing fiber to become a second laser pulse;
wherein, the second laser pulse has a bandwidth narrower than that of the first laser pulse and a unit brightness higher than that of the first laser pulse.

7. The high spectral brightness laser generating method of claim 6, wherein the dispersion-increasing fiber has a chromatic dispersion value, and the chromatic dispersion value increases with the length of the dispersion-increasing fiber.

8. The high spectral brightness laser generating method of claim 6, wherein a pulse energy outputted from the laser generator is increased to increase a wavelength of the second laser pulse.

9. The high spectral brightness laser generating method of claim 6, further comprising the step of:
increasing a pulse energy outputted from the laser generator to shift a central spectral position of the second laser pulse.

10. The high spectral brightness laser generating method of claim 6, further comprising the step of:
increasing a pulse amplitude outputted from the laser generator to decrease the bandwidth of the second laser pulse.
